(19) United States
(12) Patent Application Publication
(10) Pub. No.: US 2004/0103209 A1
(43) Pub. Date: May 27, 2004

(54) System and method for controlling switch devices supporting generalized multi-protocol label switching

(75) Inventors: Satoshi Kinoshita, Tokyo (JP); Toshiya Okabe, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/718,590

(22) Filed: Nov. 24, 2003

(30) Foreign Application Priority Data
Nov. 26, 2002 (JP) 2002-342690

(51) Int. Cl. G06F 15/173

(52) U.S. Cl. 709/238

(57) ABSTRACT

A GMPLS controller used for a GMPLS network is provided. The GMPLS controller includes a resource manager responsive to a label request for managing labels, and for issuing a device setup request, and a switch controller controlling setup of a switching device in response to the device setup request. The switch controller is separated from the resource manager.

### BACKGROUND OF THE INVENTION

1. Field of the Invention

The present invention is generally related to a system and method for controlling switch devices for a Generalized Multi-Protocol Label Switching (GMPLS) network, more particularly, to a technique for label management of a GMPLS network.

2. Description of the Related Art

MPLS designates a label switching mechanism with IP control plane initially designed to increase forwarding performance. Japanese Patent Application No. P2001-298475A discloses an MPLS network using a distance vector routing protocol for achieving routing with a reduced number of labels. Japanese Patent Application No. P2000-341294A discloses an MPLS packet transfer apparatus for promoting efficient use of labels.

In order to extend MPLS from supporting packet (PSC) interfaces and switching to include support of three new classes of interfaces and switching: Time-Division Multiplex (TDM), Lambda Switch (LSC) and Fiber-Switch (FSC), generalized MPLS (GMPLS) has been recently proposed by several standardization organizations, such as Internet Engineering Task Force (IETF), and standardization of GMPLS is currently going on. Generalized MPLS allows communication systems to treat optical signals as well as packets on the basis of label switching technologies.

Although achieving controls of different kinds of switching devices, conventional Generalized MPLS networks require different controllers for different switching devices. This undesirably increases hardware and cost of GPMLS controllers.

Therefore, there is a need for providing a GMPLS controller controlling different kinds of switching devices with reduced hardware and cost.

### SUMMARY OF THE INVENTION

An object of the present invention is to provide a GMPLS controller controlling different kinds of switching devices with reduced hardware and/or cost.

In an aspect of the present invention, a GMPLS controller used for a GMPLS network is composed of a resource manager responsive to a label request for managing labels, and for issuing a device setup request, and a switch controller controlling setup of a switching device in response to the device setup request. The switch controller is separated from the resource manager.

In another aspect of the present invention, a GMPLS controller is composed of a plurality of switch controllers controlling a plurality of switch devices, a port information table, and a resource manager. Each of the switch devices includes at least one port. The port information table describes an association of the ports to the switch controllers. The resource manager is responsive to a label request indicative of a target port selected out of the ports for managing labels, and for issuing a device setup request. The resource manager consults the port information table to determine a target switch controller associated with the target port out of the plurality of switch controllers, and provides the device setup request for the target switch controller. The target switch controller updates a setup of the switch device associated with the target switch controller.

The GMPLS controller preferably includes a label database describing whether each of the labels is in use or not. In response to the label request, the resource manager updates the label database to indicate that a target label indicated by the label request is in use.

The GMPLS controller may include at least one port-to-port connection controller for achieving a port-to-port connection between two out of the plurality of switch devices. In this case, it is advantageous that the port information table preferably describes an association of the ports to the at least one port-to-port connection controller, that the resource manager is responsive to a port-to-port connection request indicative of another target port selected out of the ports for managing the labels, and for issuing another device setup request, and that the resource manager consults the port information table to determine a target port-to-port connection controller associated with the another target port out of at least one port-to-port connection controller, and provides the another device setup request for the target port-to-port connection controller.

When the switch controllers respectively include interfaces, and the interfaces preferably use the same protocol to receive the device setup request.

The plurality of switch devices may include at least two out of an MPLS switch, a TDM switch, a Lambda switch, and a fiber switch.

The resource manager preferably manages bandwidth information of the GMPLS network.

It is also preferable that the resource manager manages LSP information of the GMPLS network.

In still another aspect of the present invention, a GMPLS controller system used in a GMPLS network is composed of a plurality of GMPLS controllers. Each of the GMPLS controllers includes a switch controller controlling a switch device, and a resource manager responsive to a label request for managing labels, and for issuing a device setup request. The resource managers of the plurality of GMPLS controllers use the same algorithm for issuing the device setup requests.

When the plurality of switch controllers preferably include interfaces, respectively, the interfaces preferably uses the same protocol to receive the device setup request.

In still another aspect of the present invention, a method for controlling switch devices provided for a GMPLS network, is composed of:

providing a GMPLS controller including:

a plurality of switch controllers controlling a plurality of switch devices, respectively, each of the plurality of switch devices including at least one port;

a port information table describing an association of the ports to the plurality of switch controllers;

providing a label request indicative of a target port selected out of the ports;

consulting the port information table to determine a target switch controller associated with the target port out of the plurality of switch controllers;

providing a device setup request for the target switch controller; and

updating a setup of the switch device associated with the target switch controller in response to the device setup request.

### BRIEF DESCRIPTION OF THE DRAWINGS

FIG. 1 is a schematic block diagram of a GMPLS controller in one embodiment of the present invention;

FIG. 2 illustrates entries of label information tables provided for the GMPLS controller;

FIG. 3 illustrates entries of a port information table provided for the GMPLS controller;

FIG. 4 is a flowchart illustrating a procedure of updating setup of a switch device in response to a label request;

FIG. 5 is a flowchart illustrating a procedure of updating setup of a switch device in response to a port-to-port connection request; and

FIG. 6 is a schematic block diagram of a GMPLS controller in an alternative embodiment of the present invention.

### DESCRIPTION OF THE PREFERRED EMBODIMENTS

Preferred embodiments of the present invention are described below in detail with reference to the attached drawings.

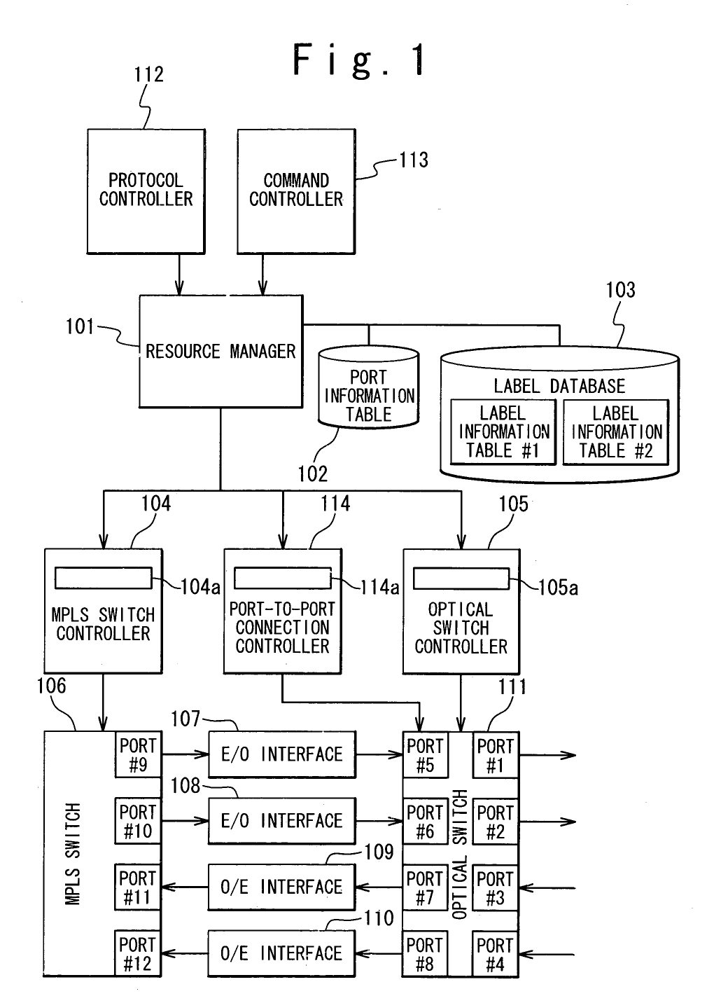

In one embodiment, as shown in FIG. 1, different kinds of switch devices: an MPLS switch 106, and an optical switch 111, are controlled by a GMPLS controller including a resource manager 101, a port information table (PIT) 102, a label database 103, an MPLS switch controller 104, an optical switch controller 105, a protocol controller 112, a command controller 113, and a port-to-port connection controller 114.

The MPLS switch 106 includes a plurality of ports, and routes MPLS packets from one port to another port. The ports of the MPLS switch 106 are identified by port numbers #9 through #12.

The MPLS switch 106 is connected to the optical switch 111 through electro-optical (E/O) interfaces 107, 108, and optical-to-electronic (O/E) interfaces 109, and 110. The E/O interfaces 107 and 108 convert electrical signals, that is, MPLS packets from the MPLS switch 106 to optical signals. The O/E interfaces 109 and 110 converts optical signals received from the optical switch 111 to MPLS packets. The port #9 and #10 of the MPLS switch 106 are connected to inputs of the E/O interfaces 107 and 108, respectively, and the ports #11 and #12 are connected to outputs of O/E interfaces 109 and 110.

The optical switch 111 also includes a plurality of ports, and routes optical signals from one port to another port. A TDM switch, a Lambda switch, and a fiber switch may be used as the optical switch 111. The ports of the optical switch 111 are identified by port numbers #1 through #8. The ports #1 and #2 are used to output optical signals to other nodes (not shown), and the ports #3 and #4 are used to receive optical signals from other nodes. The ports #5 and #6 are respectively connected to the outputs of the E/O interfaces 107 and 108, and the ports #7 and #8 are respectively connected to the inputs of the O/E interfaces 109 and 110.

The MPLS switch 106 and the optical switch 111 are respectively controlled by the MPLS switch controller 104, and the optical switch controller 105. These controllers are identified by switch controller locations. In this embodiment, the MPLS switch controller 104 is identified by the switch controller location #1, while the optical switch controller 105 is identified by the switch controller location #2.

In addition, the optical switch 111 is connected to the port-to-port connection controller 114 to establish port-to-port connections between the switch devices; that is, the MPLS switch 106 and the optical switch 111. The port-to-port connection controller 114 is identified by a connection controller location #3. It should be noted that one or more additional port-to-port connection controllers may be provided for the GMPLS controller if one or more additional switch devices are controlled by the GMPLS controller.

The MPLS switch controller 104, the optical switch controller 105, and the port-to-port connection controller 114 are controlled by the resource manager 101. The resource manager 101 provides device set-up requests for these controllers in response to label requests and port-to-port connection set-up requests, received from the protocol controller 112 or the command controller 113.

The MPLS switch controller 104, the optical switch controller 105, and the port-to-port connection controller 114 respectively include interfaces 104a, 105a, and 114a, that use the same protocol for receiving the device set-up requests from the resource manager 101. This allows the resource manager 101 to use the same control protocol regardless of the kinds of the controllers, and preferably leads to cost reduction of the GMPLS controller.

The resource manager 101 consults the port information table 102 and the label database 103 to issue the device set-up requests.

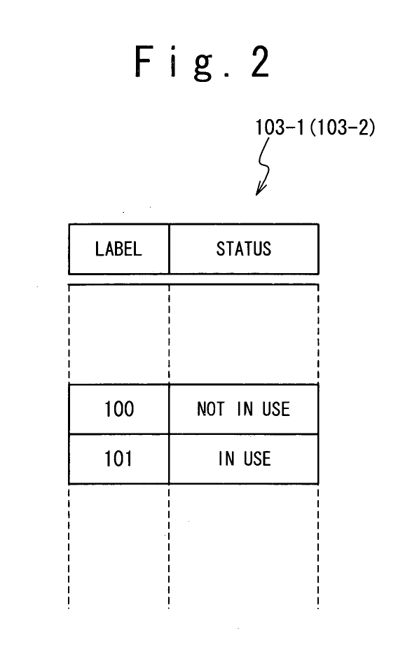

The label database 103 includes a pair of label information tables. As shown in FIG. 2, the label information tables describe whether each label is in use or not in use. The label information tables are respectively associated with the switch devices, and identified by specific LIT numbers. In this embodiment, the label information tables are identified by LIT numbers #1 and #2, respectively.

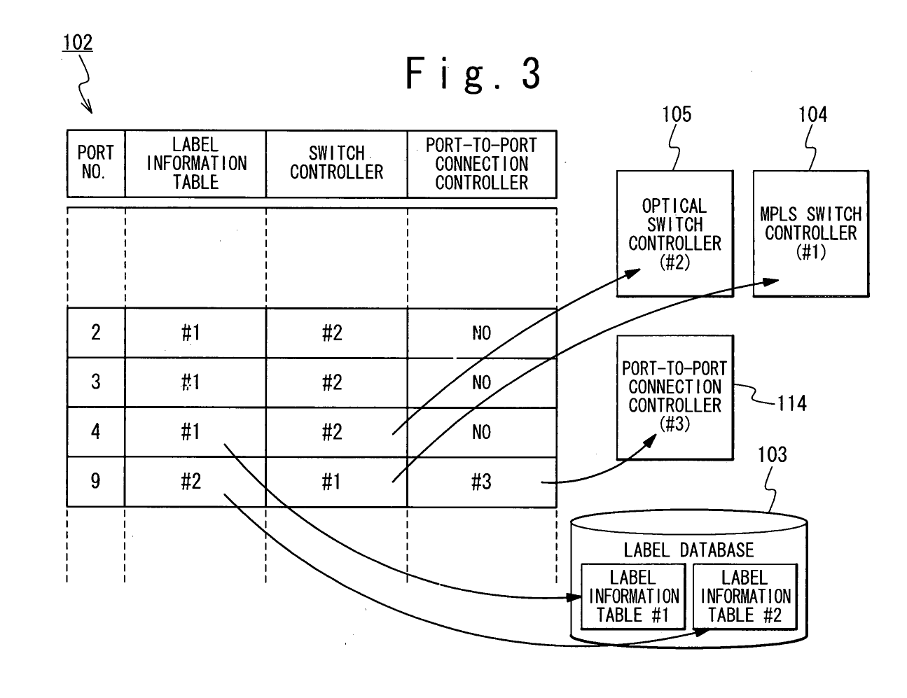

As shown in FIG. 3, the port information table 102, on the other hand, describes an association of each of the ports of the switching devices with the label information tables, the switch controllers, and the port-to-port connection controller(s). The port information table 102 includes entries respectively associated with the ports of the switch devices, and each entry includes the LIT number of the associated label information table, the locations of the associated switch device controller and port-to-port connection controller. According to the port information table 102 shown in FIG. 3, for example, the port #2 is associated the label information table identified by the LIT number #1, and the switch controller identified by the switch controller location #2 (that is, the optical switch controller 105), while the port #2 is not associated with any port-to-port connection controller.

The resource manager 101 is preferably designed to manage the bandwidth information of the GMPLS network, the LSP (label switched path) information, and other network information.

The resource manager 101 is connected to the protocol controller 112 and the command controller 113. The protocol controller 112 communicates with other nodes over a control plane of GMPLS, and provides the label requests and the port-to-port connection requests for the resource manager 101 in response to LSP (label switched path) setup requests received from the counterpart node. The command controller 113 receives commands from a remote controller (not shown) through telnet or from a control console (not shown) connected to the GMPLS controller, and provides the label requests and the port-to-port connection requests for the resource manager 101 in response to the received commands.

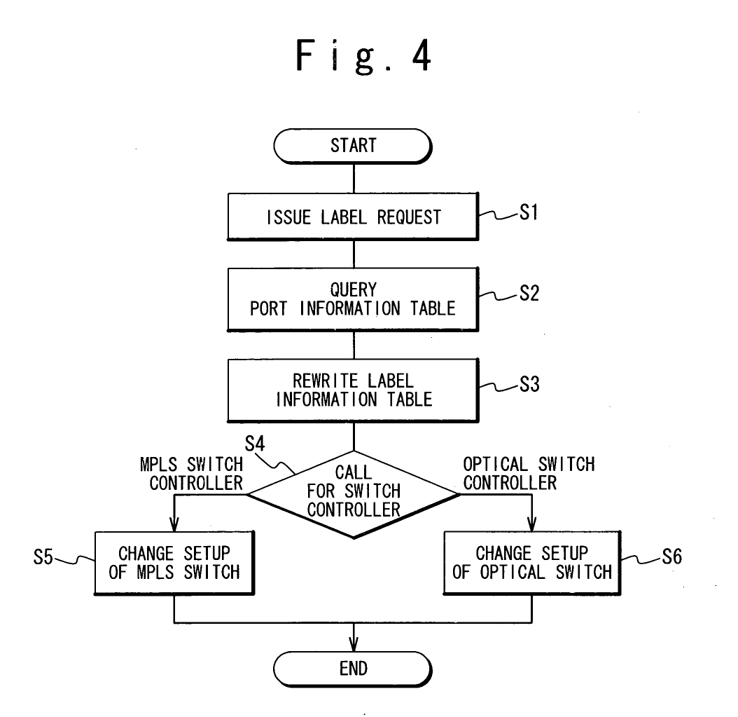

FIG. 4 is a flowchart illustrating a procedure for updating a setup of a desired switch device. When the setup of the desired switch device is requested to be updated, the protocol controller 112 or the command controller 113 issues a label request for the resource manager 101 at Step S1. The issued label request includes an incoming label, an outgoing label, an input port number, and an output port number. The input and output port numbers are used to identify input and output ports out of the ports of the switching devices.

On receiving the label request, at Step S2, the resource manager 101 consults the port information table 102 using the input and output port numbers as queries to obtain the LIT identifiers of the label information tables associated with the respective input and output ports, and the location of the switch device controller associated with the input and output ports. Assuming that the input port number is “#4”, the incoming label is “100”, the output port number is “#2”, and the outgoing label is “200”, as shown in FIG. 3, the resource manager 101 obtains the LIT identifier #1 and the switch controller location #2 for the input and output port numbers. This implies that both of the input and output ports #2 and #4 are associated with the label information table #1, and the optical switch controller 105. Referring back to FIG. 4, the procedure then goes to Step S3.

At Step S3, the resource manager 101 rewrites the label information table associated with the input and output ports to indicate that the received input and outgoing labels are in use. For the input port, the resource manager 101 refers to the label information table associated therewith using the received incoming label as a query, and rewrites the entry associated with the received incoming label to indicate that the received incoming label is in use. For the input port number #4, and the incoming label “100”, for example, the resource manager 101 rewrites the entry associated with the incoming label “100” to the state “IN USE” in the label information table #1, which is associated with the input port #4. Correspondingly, the resource manager 101 refers to the label information table associated with the output port using the received outgoing label as a query, and rewrites the entry associated with the received outgoing label to indicate that the outgoing label is in use. The procedure then goes to Step S04.

At Step S4, the resource manager 101 calls for the switch controller identified by the switch controller location obtained at Step S02, and provides the called switch controller with a device set-up request including the input port number, the incoming label, the output port number, and the outgoing label. For the input port number #4 and the output port number #2, for instance, the switch controller location #2 is obtained with reference to the port information table 102, and the optical switch controller 105, identified by the location #2, is called for by the resource manager 101.

When the MPLS switch controller 104 is called for at Step S4, the MPLS switch controller 104 updates the label setup of the MPLS switch 106 in response to the device set-up request receiving from the resource manager 101 at Step S5. The received device set-up request includes the input port number, the incoming label, the output port number, and the outgoing label, and the label setup of the MPLS switch 106 is updated so that, when receiving an MPLS packet with the incoming label through the input port, the MPLS switch 106 attaches the outgoing label to the MPLS packet and outputs it through the output port.

When the optical switch controller 105 is called for at Step S4, on the other hand, the optical switch controller 105 updates the setup of the optical switch 111 in response to the device set-up request receiving from the resource manager 101 at Step S6. The setup of the optical switch 111 is updated so that, when receiving an optical signal associated with the incoming label through the input port, the optical switch 111 outputs the received optical signal through the output port.

For the input port number #4, the incoming label “100”, the output port number #2, and the outgoing label “200”, for example, the switch controller location #2 is obtained at Step S2, and thus the optical switch controller 105 is called for at Step S4 using the switch controller location #2. The device setup request is then provided for the optical switch controller 105 from the resource manager 101. In response to the device setup request, the optical switch controller 105 updates the setup of the optical switch 111.

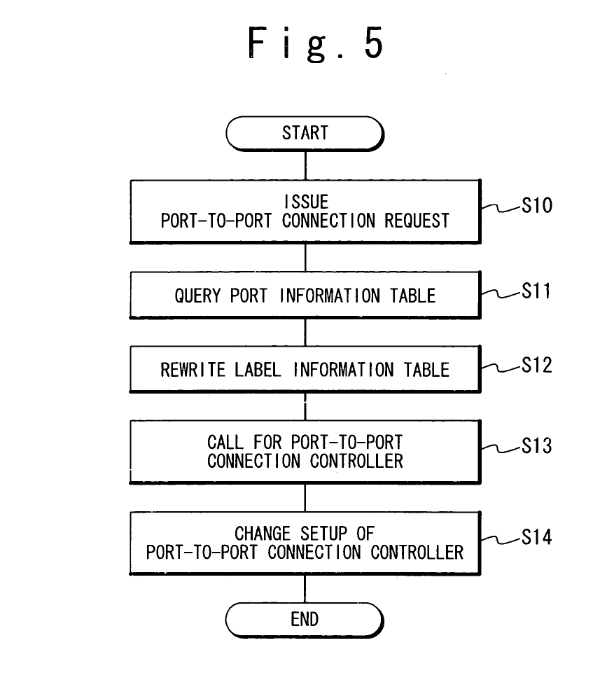

FIG. 5 is a flowchart illustrating a procedure for establishing a port-to-port connection between different switch devices (that is, the MPLS switch 106 and the optical switch 111). When a port-to-port connection is requested, the protocol controller 112 (or the command controller 113) provides the resource manager 101 with a port-to-port connection request at Step S10. The port-to-port connection request includes an input port connection establishment set or an output port connection establishment set. The input port connection establishment set is composed of an incoming label, an input port number, and a counterpart port number, while the output port connection establishment set is composed of an outgoing label, an output port number, and a counterpart port number. The counterpart port number is used to identify a counterpart port to be connected to the input port or the output port.

On receiving the port-to-port connection request, at Step S11, the resource manager 101 queries the port information table 102 using the input port number (or the output port number) as a query to obtain the LIT identifier of the label information table associated with the input port (or the output port), and the location of the port-to-port connection controller associated with the counterpart port.

For the output port number #2, the outgoing label “200”, and the counterpart port number #9, for example, the resource manager 101 obtains the LIT identifier #1 for the output port #2, while obtaining the connection controller location #3 for the counterpart port #9.

At Step S12, the resource manager 101 rewrites the label information table associated with the input port (or the output port) to indicate that the received incoming label (or the outgoing label) is in use. For the input port, the resource manager 101 refers to the label information table associated with the input port using the received incoming label as a query, and rewrites the entry associated with the incoming label to indicate that the received incoming label is in use. The same goes for the output port. For the output port, the resource manager 101 refers to the label information table associated with the output port using the outgoing label as a query, and rewrites the entry associated with the outgoing label to indicate that the outgoing label is in use. For the output port number #2, and the outgoing label “200”, the resource manager 101 rewrites the entry associated with the outgoing label “200” to the state “IN USE” in the label information table #1, which is associated with the output port #2.

The procedure then goes to Step S13. At Step S13, the resource manager 101 calls for the port-to-port connection controller identified by the connection controller location obtained at Step S11, and provides the called port-to-port connection controller with a device set-up request including selected one of the input and output port connection establishment sets. For the counter part number #9, for example, the port-to-port connection controller location #3 is obtained at Step S11 with reference to the port information table 102, and the port-to-port connection controller 114, identified by the location #3, is called for by the resource manager 101.

The procedure then goes to Step S14.

The called port-to-port connection controller updates the setup of the switch device associated therewith in response to the device set-up request, which includes selected one of the input and output port connection establishment sets. When the device set-up request includes the input port connection establishment set, the called port-to-port connection controller updates the setup of the associated switch device so that a port-to-port connection is established between the input port and the counterpart port. When the device set-up request includes the output port connection establishment set, on the other hand, the called port-to-port connection controller updates the setup of the associated switch device so that a port-to-port connection is established between the output port and the counterpart port.

For the output port number #2, and the counterpart port number #9, for instance, the resource manager 101 calls for the port-to-port connection controller 114, and the port-to-port connection controller 114 updates the setup of the optical switch 111 associated therewith so that a port-to-port connection between the port #9 of the MPLS switch 106 and the port #2 of the optical switch 111.

One of the features of the GMPLS controller in this embodiment is that the resource controller 101, which manages the labels used in the GMPLS networks, is separated from the switch controllers, and is adapted to update the setups of the different kinds of switch devices through indicating the respective switch controllers which are respectively designed to control different switch devices. The port information table 102, which describes the association of the ports of the switch devices with the switch controllers, advantageously provides the resource controller 101 with necessary information for communicating with a desired switch controller whose setting is to be updated. The use of the port information table 102 is also advantageous because it allows the GMPLS controller to flexibly adapt updates in the topology of the GMPLS network.

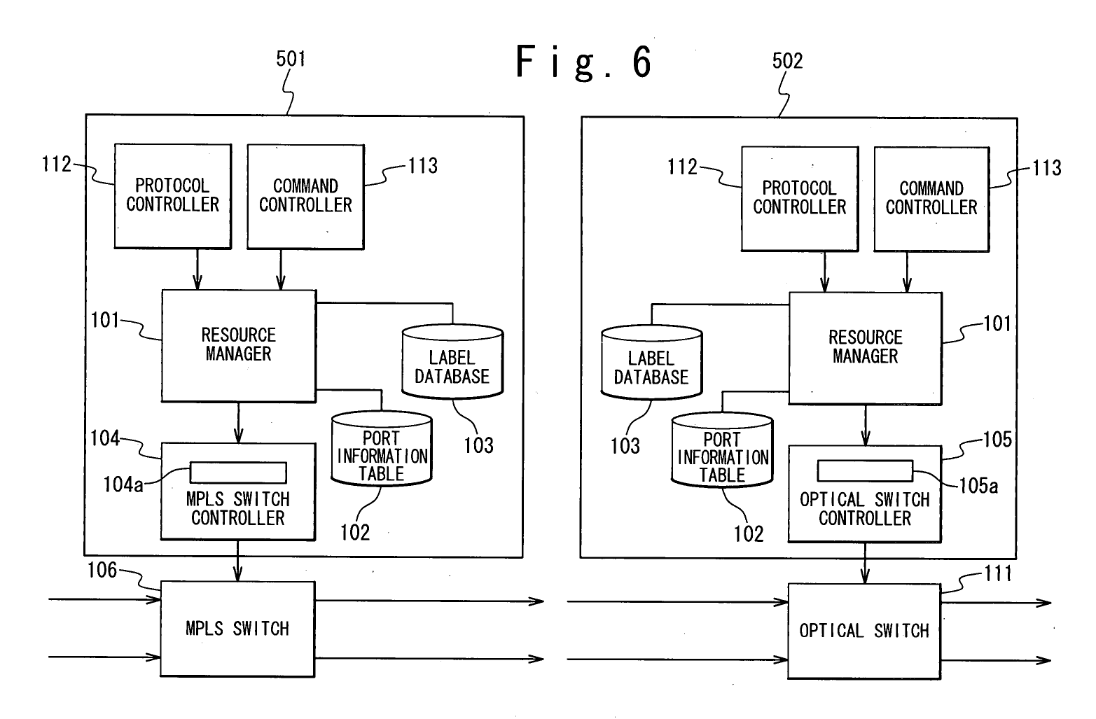

In an alternative embodiment, as shown in FIG. 6, in which like elements are designated with identical reference numerals to those in FIGS. 1 through 5, a plurality of GMPLS controllers 501 and 502 are provided to control the same number of switch devices, which are designated with reference numerals 106 and 111, respectively. Each of the GMPLS controllers includes a protocol controller 112, a command controller 113, a resource manager 101, a port information table 102, a label database 103, and a single switch controller. The GMPLS controller 501 includes a MPLS switch controller 104, while the GMPLS controller 502 includes an optical switch controller 105. It should be noted that each of the GMPLS controllers includes a single switch controller, and the label database 103 includes a single label information table, and that each of the port information tables 102 describes a single LIF identifier of the associated label information table and a single switch controller location of the associated switch controller. This implies that when a label setup request issued in a given GMPLS controller, the associated resource controller 101 unconditionally calls for the switch controller within the given GMPLS controller.

The resource controllers 101 are separated from the switch controllers 104 and 105, and are adapted to update the setups of the different kinds of switch devices through indicating the associated switch controllers. To satisfy this requirement, the resource controllers 101 support the same control protocol to issue device setup requests, and the switch controllers includes the same interfaces adapted to support the control protocol. This effectively reduces cost of the GMPLS controllers.

Although the invention has been described in its preferred form with a certain degree of particularity, it is understood that the present disclosure of the preferred form has been updated in the details of construction and the combination and arrangement of parts may be resorted to without departing from the scope of the invention as hereinafter claimed. Especially, it should be noted that the topology of the GMPLS network may be updated.

What is claimed is:

1. A GMPLS controller used for a GMPLS network comprising:
a resource manager responsive to a label request for managing labels, and for issuing a device setup request;
a switch controller controlling setup of a switching device in response to said device setup request, said switch controller being separated from said resource manager.

2. A GMPLS controller comprising:
a plurality of switch controllers controlling a plurality of switch devices, respectively, each of said plurality of switch devices including at least one port;
a port information table describing an association of said ports to said plurality of switch controllers; and
a resource manager responsive to a label request indicative of a target port selected out of said ports for managing labels, and for issuing a device setup request,
wherein said resource manager consults said port information table to determine a target switch controller associated with said target port out of said plurality of switch controllers, and provides said device setup request for said target switch controller, and
wherein said target switch controller updates a setup of said switch device associated with said target switch controller.

3. The GMPLS controller according to claim 2, further comprising:
a label database describing whether each of said labels is in use or not,
wherein said label request is indicative of a target label, and
wherein said resource manager updates said label database to indicate that said target label is in use.

4. The GMPLS controller according to claim 2, further comprising:
at least one port-to-port connection controller for achieving a port-to-port connection between two out of said plurality of switch devices,
wherein said port information table describes an association of said ports to said at least one port-to-port connection controller,
wherein said resource manager is responsive to a port-to-port connection request indicative of another target port selected out of said ports for managing said labels, and for issuing another device setup request,
wherein said resource manager consults said port information table to determine a target port-to-port connection controller associated with said another target port out of at least one port-to-port connection controller, and provides said another device setup request for said target port-to-port connection controller.

5. The GMPLS controller according to claim 2, wherein said plurality of switch controllers include interfaces, respectively, and said interfaces use the same protocol to receive said device setup request.

6. The GMPLS controller according to claim 2, wherein said plurality of switch devices include at least two out of an MPLS switch, a TDM switch, a Lambda switch, and a fiber switch.

7. The GMPLS controller according to claim 2, wherein said resource manager manages bandwidth information of said GMPLS network.

8. The GMPLS controller according to claim 2, wherein said resource manager manages LSP information of said GMPLS network.

9. A GMPLS controller system used in a GMPLS network, comprising:
a plurality of GMPLS controllers each of which includes:
a switch controller controlling a switch device;
a resource manager responsive to a label request for managing labels, and for issuing a device setup request,
wherein said resource managers of said plurality of GMPLS controllers use a same algorithm for issuing said device setup requests.

10. The GMPLS controller system according to claim 9, wherein each of said switching device is selected out of a MPLS switch, a fiber switch, a TDM switch, and a Lambda switch.

11. The GMPLS controller system according to claim 10, wherein said plurality of switch controllers include interfaces, respectively, and said interfaces uses a same protocol to receive said device setup request.

12. The GMPLS controller system according to claim 9, wherein said resource manager manages bandwidth information of said GMPLS network.

13. The GMPLS controller according to claim 9, wherein said resource manager manages LSP information of said GMPLS network.

14. A method for controlling switch devices provided for a GMPLS network, comprising:
providing a GMPLS controller including:
a plurality of switch controllers controlling a plurality of switch devices, respectively, each of said plurality of switch devices including at least one port;
a port information table describing an association of said ports to said plurality of switch controllers;
providing a label request indicative of a target port selected out of said ports;
consulting said port information table to determine a target switch controller associated with said target port out of said plurality of switch controllers;
providing a device setup request for said target switch controller; and
updating a setup of said switch device associated with said target switch controller in response to said device setup request.
